(19) United States
(12) Patent Application Publication
(10) Pub. No.: US 2015/0309759 A1
(43) Pub. Date: Oct. 29, 2015

(54) TERMINAL APPARATUS, OUTPUT SYSTEM, AND OUTPUT METHOD

(71) Applicant: Shinya MORI, (US)

(72) Inventor: Shinya Mori, Tokyo (JP)

(73) Assignee: RICOH COMPANY, LTD., Tokyo (JP)

(21) Appl. No.: 14/647,855

(22) PCT Filed: Dec. 17, 2013
(86) PCT No.: PCT/JP2013/084393

§ 371 Date: May 28, 2015

(30) Foreign Application Priority Data
Dec. 27, 2012 (JP) 2012-285040

(51) Int. Cl. G06F 3/12

(52) U.S. Cl. CPC G06F 3/1285; G06F 3/1205; G06F 3/1256; G06F 3/1258

(57) ABSTRACT

A terminal apparatus capable of communicating with an image forming apparatus includes an output management unit configured to manage first output data stored in a first output data storage part, the first output data being created based on data to be output, and being independent of the image forming apparatus; a second data creating unit configured to create second output data based on the first output data, the second output data being dependent on the image forming apparatus; an output data process unit configured to receive a second output data acquiring request to acquire the second output data from the image forming apparatus, and instruct the second data creating unit to create the second output data based on the first output data stored in the first output data storage part; and a transmitting unit configured to transmit the created second output data to the image forming apparatus.

### TECHNICAL FIELD

The disclosures herein are generally related to a terminal apparatus, an output system, and an output method.

### BACKGROUND ART

There is an output system, that is, a so-called pull printing system known in the art, one example of which may be disclosed in Japanese Laid-open Patent Publication No. 2007-200284 (hereinafter referred to as “Patent Document 1”). In such a pull printing system, data to be printed is specified from a printer apparatus, a data area to be printed specified based on the specification or a print job based on the data to be printed is captured by the printer apparatus, and printing is performed based on the captured data.

In such a related art output system such as the pull printing system, the print jobs are temporarily stored in a format (e.g., page description language: PDL) that may be printed (output) by the image forming apparatus such as a printer. However, when the print job is stored in the format capable of being output by the image forming apparatus, displaying a preview image on the operations panels of the image forming apparatus, or changing print settings may be needed corresponding to the PDL which has dependency on various specifications and models. This kind of dependency problem is not only likely to occur in the image forming apparatus that performs printing but also in the image forming apparatus having a display format or an output format that has dependency on various specifications and models.

### RELATED ART DOCUMENTS

### Patent Document

Patent Document 1: Japanese Laid-open Patent Publication No. 2007-200284

### DISCLOSURE OF THE INVENTION

It is a general object of at least one embodiment of the present invention to provide a terminal apparatus, an output system, and an output method that substantially obviate one or more problems caused by the limitations and disadvantages of the related art.

According to one embodiment of the present invention, there is provided a terminal apparatus capable of communicating with an image forming apparatus. The terminal apparatus includes an output management unit configured to manage first output data stored in a first output data storage part, the first output data being created based on data to be output, and being independent of the image forming apparatus; a second data creating unit configured to create second output data based on the first output data, the second output data being dependent on the image forming apparatus; an output data process unit configured to receive a second output data acquiring request to acquire the second output data from the image forming apparatus, and instruct the second data creating unit to create the second output data based on the first output data stored in the first output data storage part; and a transmitting unit configured to transmit the created second output data to the image forming apparatus.

Other objects, features and advantages of embodiments will be apparent from the following detailed description when read in conjunction with the accompanying drawings.

### BRIEF DESCRIPTION OF THE DRAWINGS

FIG. 1 is a configuration diagram illustrating an example of an output system according to an embodiment;

FIG. 2 is a hardware configuration diagram illustrating an example of a computer system according to an embodiment;

FIG. 3 is a hardware configuration diagram illustrating an example of an image forming apparatus according to an embodiment;

FIG. 4 is a process block diagram illustrating an example of a terminal apparatus 10;

FIG. 5 is a detailed process block diagram illustrating the terminal apparatus;

FIG. 6 is a process block diagram illustrating an example of the image forming apparatus;

FIG. 7 is a process block diagram illustrating an example of an authentication device;

FIG. 8 is a sequence diagram illustrating an example of a pull printing process;

FIG. 9 is a flowchart illustrating an example of a print job accumulating process in the terminal apparatus;

FIG. 10 is a configuration diagram illustrating an example of an intermediate print data list;

FIG. 11 is a sequence diagram illustrating an example of a login process;

FIG. 12 is a configuration diagram illustrating an example of user data.

FIG. 13 is a sequence diagram illustrating an example of a preview image display process;

FIG. 14 is a sequence diagram illustrating an example of a printing process; and

FIG. 15 is a configuration diagram illustrating an example of a RAW data acquiring request.

### MODE FOR CARRYING OUT THE INVENTION

In the following, embodiments of the present invention are described with reference to the accompanying drawings.

### First Embodiment

### System Configuration

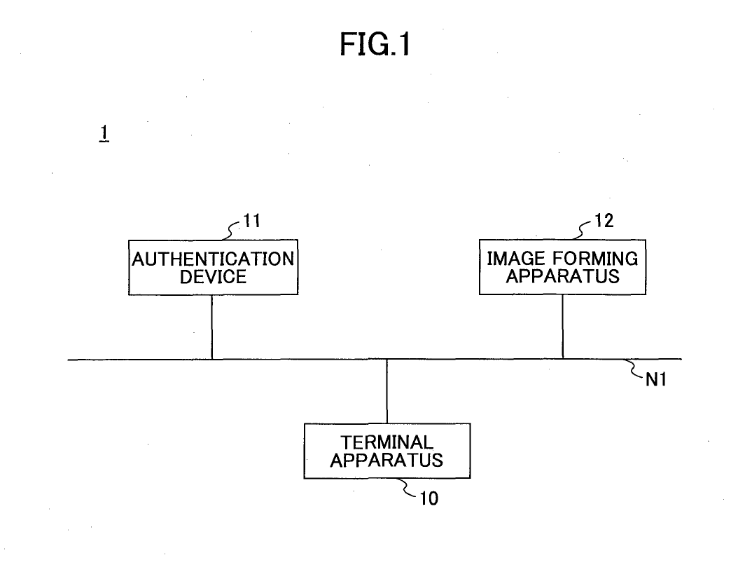

FIG. 1 is a configuration diagram illustrating an example of an output system 1 according to an embodiment. In the output system 1 in FIG. 1, a terminal apparatus 10, an authentication device 11, and an image forming apparatus 12 are connected to one another via a network N1 such as the Internet or LAN (local area network) so as to communicate data between the terminal apparatus 10, the authentication device 11, and the image forming apparatus 12.

The terminal apparatus 10 may, for example, be a client terminal or a mobile terminal. The terminal apparatus 10 may be implemented by an information processing apparatus (a computer system) having a general-purpose OS (operating system) installed therein. The terminal apparatus 10 includes a wireless or a wired communication unit. The terminal apparatus 10 may be a tablet PC, a note PC, a smartphone, or a mobile phone that may be operated by a user.

The authentication device 11 is used for user authentication in the image forming apparatus 12. The authentication device 11 may be implemented by an information processing apparatus having a general-purpose OS (operating system) installed therein. Note that the authentication device 11 is not mandatory for the output system 1.

The image forming apparatus 12 is configured to include an image forming function, such as a multifunctional peripheral. The image forming apparatus 12 includes a wireless or a wired communication unit. The image forming apparatus 12 is configured to perform image forming processes performed by a multifunctional peripheral, a copier, a scanner, a printer, and a laser printer. The image forming apparatus 12 may be a projector, or the like. FIG. 1 illustrates the output system 1 that includes the terminal apparatus 10, the authentication device 11, and the image forming apparatus 12. However, the output system 1 may include two or more of the terminal apparatuses 10, authentication devices 11, and image forming apparatuses 12.

### Hardware Configuration

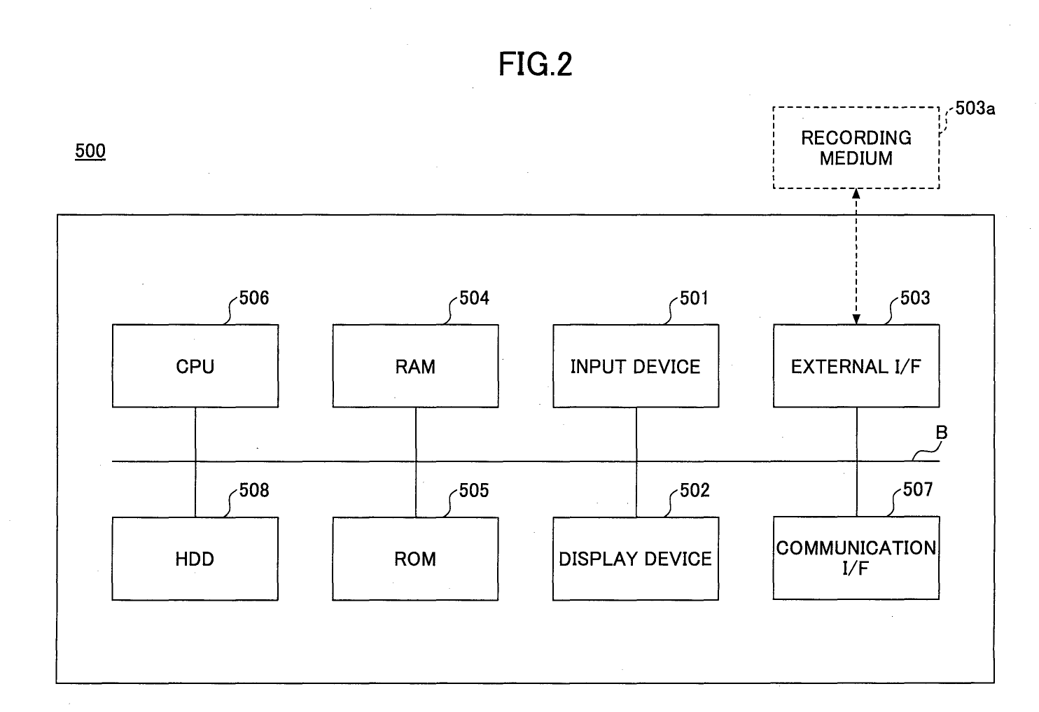

The terminal apparatus 10 and the authentication device 11 each may be implemented by computer systems having a hardware configuration illustrated in FIG. 2.

FIG. 2 is a hardware configuration diagram illustrating an example of a computer system 500 according to an embodiment. The computer system 500 illustrated in FIG. 2 includes an input device 501, a display device 502, an external I/F (interface) 503, a RAM (random access memory) 504, a ROM (read only memory) 505, a CPU (central processing unit) 506, a communication I/F (interface) 507, an HDD (hard disk drive) 508, and the like that communicate with one another via a bus B.

The input device 501 includes a keyboard, a mouse, a touch panel and the like that are used by the user to input various types of operations signals. The display device 502 includes a display and the like, and is configured to display processed results produced by the computer system 500.

The communication I/F 507 serves as an interface configured to connect the computer system 500 to the network N1. Hence, the computer system 500 may be able to communicate data via the communication I/F 507.

The HDD 508 is a nonvolatile recording device configured to store programs or data. Examples of such programs or data stored in the HDD 508 may include an OS (operating system) serving as basic software configured to control the overall computer system 500, or application software that provides various functions on the OS. The HDD 508 is configured to manage the stored programs or data by a predetermined file system and/or a DB (database).

The external I/F 503 is configured to serve as an interface between an external device and the computer system 500. The external device may include a recording medium 503a. Hence, the computer system 500 may be able to read data from or write data onto the recording medium 503a via the external I/F 503. Examples of the recording medium 503a include a flexible disk, a CD (compact disk), a DVD (digital versatile disk), an SD (secure digital) memory card, a USB (universal serial bus) memory, and the like.

A ROM (read only memory) 505 is nonvolatile semiconductor memory (a nonvolatile storage device) configured to retain programs or data when the power is switched off. The ROM 505 is configured to store programs or data utilized for setting BIOS (basic input/output system), an OS, and a network. A RAM (random access memory) 504 is volatile semiconductor memory (a volatile storage device) configured to temporarily retain programs or data.

A CPU (central processing unit) 506 may be a processor device that is configured to implement an overall control over the computer system 500 or functions of the computer system 500. The overall control or functions may be implemented by retrieving programs or data from the storage device such as the ROM 505 and the HDD 508 to the RAM 504, and executing the retrieved programs or executing processes using the retrieved data. The terminal apparatus 10 and the authentication device 11 may be able to implement later-described various processes by having a hardware configuration of the computer system 500 illustrated in FIG. 2.

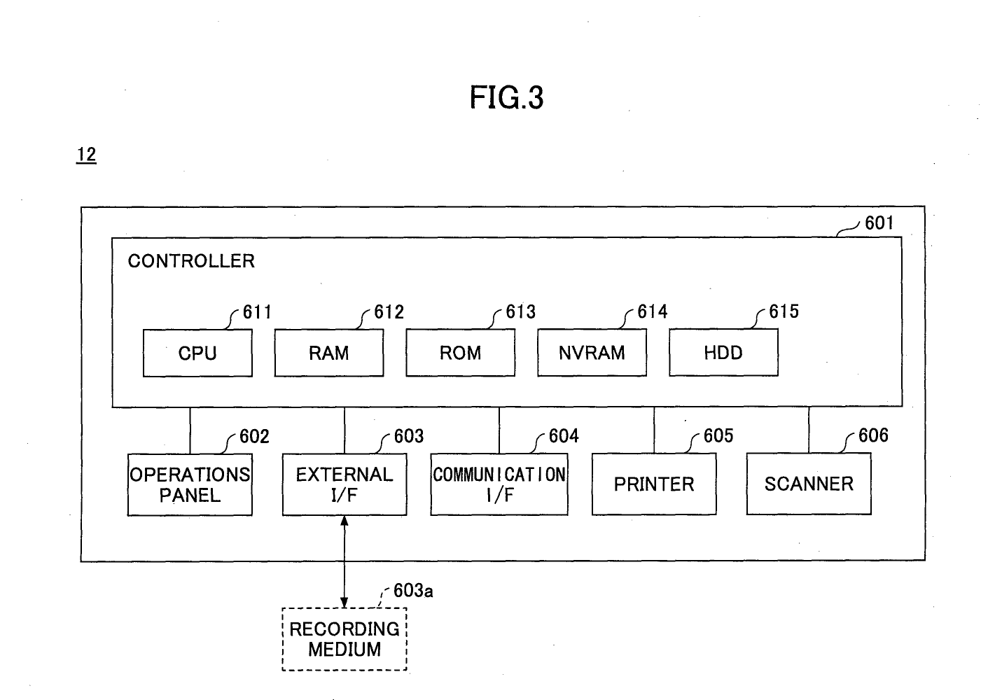

FIG. 3 is a hardware configuration diagram illustrating an example of an image forming apparatus 12 according to an embodiment. The image forming apparatus 12 illustrated in FIG. 3 includes a controller 601, an operations panel 602, an external I/F 603, a communication I/F 604, a printer 605, and a scanner 606.

The controller 601 includes a CPU 611, a RAM 612, a ROM 613, an NVRAM (nonvolatile random access memory) 614, and an HDD 615. The ROM 613 is configured to store various programs or data. The RAM 612 is configured to temporarily store programs or data. The NVRAM 614 is configured to store setting information and the like, for example. In addition, the HDD 615 is configured to store various programs or data.

The CPU 611 may implement overall control over the image forming apparatus 12 or functions of the image forming apparatus 12. The overall control or functions may be implemented by loading programs, data, or setting information into the RAM 612 that are retrieved from the storage device such as the ROM 613, the NVRAM 614, and the HDD 615, and executing the retrieved programs or executing processes using the retrieved data, or setting information.

The operations panel 602 includes an input part configured to receive input information from the user, and a display part configured to display the received information and the like. The external I/F 603 is configured to serve as an interface between an external device and the image forming apparatus 12. The external device may include a recording medium 603a.

Hence, the image forming apparatus 12 may be able to read data from or write data onto the recording medium 603a via the external I/F 603. Examples of the recording medium 603a include an IC card (an integrated circuit card), a flexible disk, a CD, a DVD, an SD memory card, a USB memory, and the like.

The communication I/F 604 serves as an interface to connect the image forming apparatus 12 to the network N1. Hence, the image forming apparatus 12 may be able to communicate data with other apparatuses via the communication I/F 604. The printer 605 is a printer apparatus for printing print data onto sheets of paper. The scanner 606 serves as a reading apparatus for reading image data from a document. The image forming apparatus 12 according to the embodiment having the above-described configuration may be able to implement later-described various processes.

### Software Configuration

### Terminal Apparatus 10

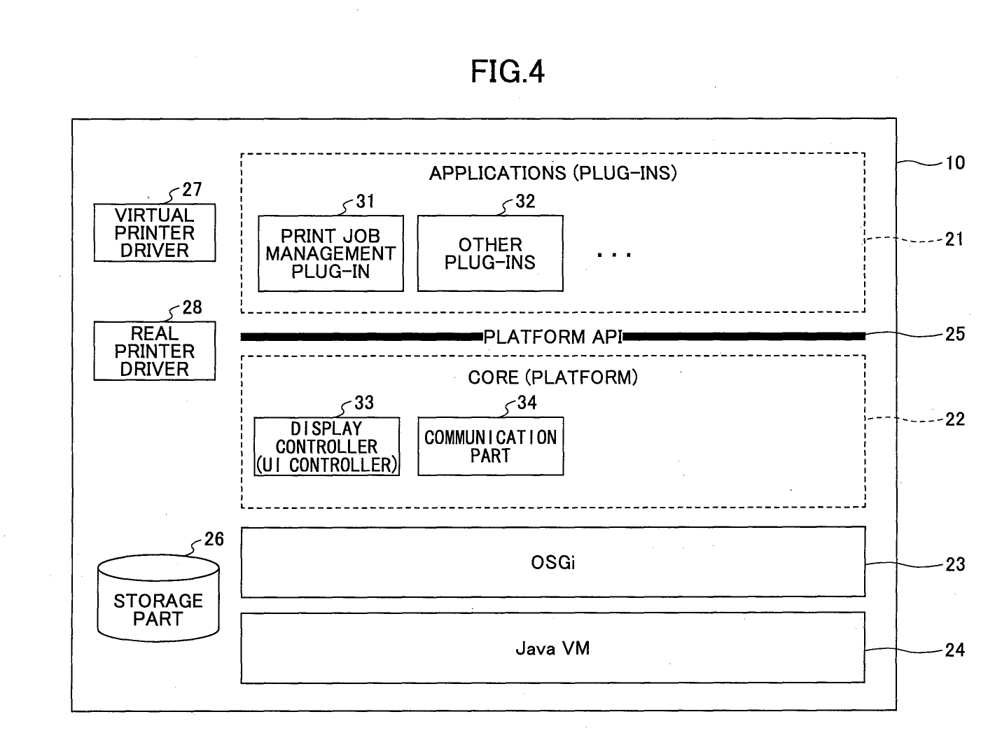

The terminal apparatus 10 according to an embodiment may be able to be implemented by process blocks illustrated in FIG. 4, for example. FIG. 4 is a process block diagram illustrating an example of the terminal apparatus 10.

The terminal apparatus 10 in FIG. 4 is configured to implement applications (Plug-ins) 21, a platform (Core) 22, an OSGi (Open Service Gateway Initiative) platform 23, a Java VM (virtual machine) 24, a platform API (Application Programming Interface) 25, a storage part 26, a virtual printer driver 27, and a real printer driver 28.

The applications 21 include a print job management plug-in 31, and other plug-ins 32. The print job plug-in 31 is configured to perform later-described print job management. The other plug-ins 32 are configured to perform some kind of processes. Note that the other plug-ins 32 are not mandatory for the terminal apparatus 10.

The platform API 25 serves as an interface for the print job management plug-in 31 and other plug-ins 32 to utilize the platform 22. The platform API 25 may be composed of functions and classes, for example. The platform API 25 is a predefined interface disposed so as to allow the platform (Core) 22 to receive a request from the applications 21.

The platform (Core) 22 includes a display controller (UI controller) 33, and a communication part 34. The display controller 33 is configured to control display of the display device 502 based on the request from the applications 21. The communication part 34 is configured to implement communications between the image forming apparatus 12 and the terminal apparatus 10. For example, the communication part 34 may transfer print data and/or a print data list to the image forming apparatus 12.

The OSGi (Open Services Gateway initiative) platform 23 serves as an infrastructure system (OSGi framework) for managing dynamic addition or execution of the plug-ins (Java modules). The Java VM (virtual machine) 24 serves as an execution environment of the plug-ins. Note that the OSGi platform 23 and Java VM 24 are existing technologies, and descriptions of these are thus omitted from the specification.

The storage part 26 is configured to store later-described intermediate print data and printer driver information. The virtual printer driver 27 is configured to create intermediate print data based on application data created by desired applications. Note that the intermediate print data do not depend on the model of the image forming apparatus 12. The data in an XPS (XML paper specification) format are an example of the intermediate print data. The real printer driver 28 is configured to create print data in a RAW format based on the intermediate print data. The print data in the RAW format depend upon the model of the image forming apparatus 12. The print data in the RAW format are hereinafter called “RAW data”.

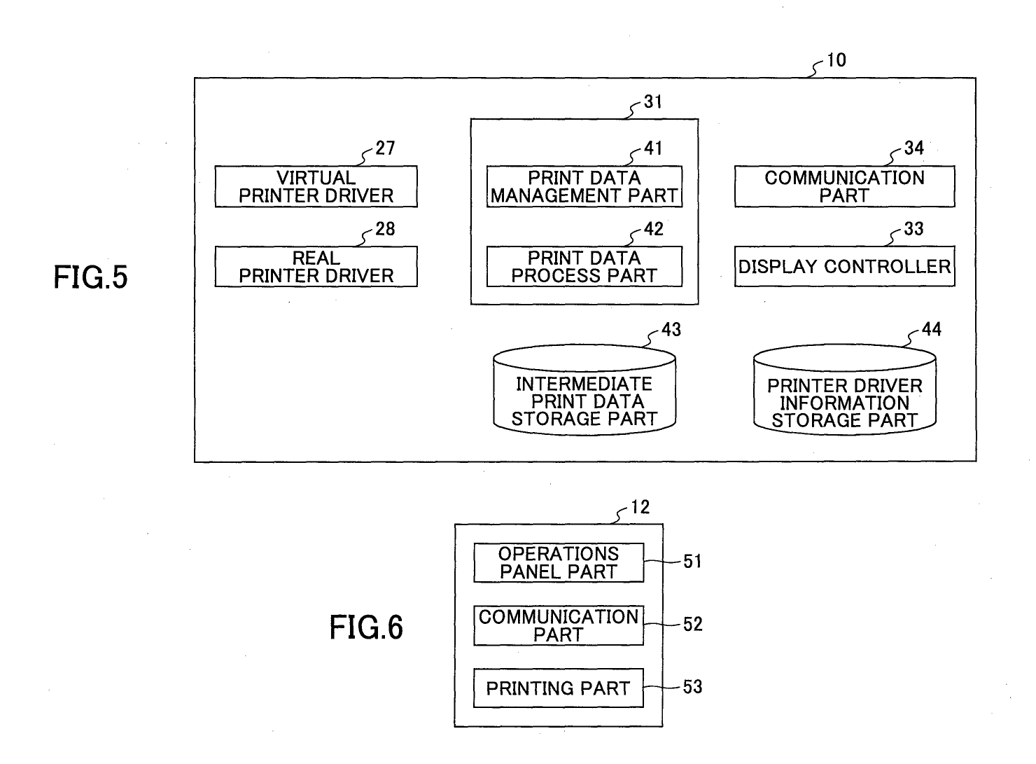

FIG. 5 is a detailed process block diagram illustrating the terminal apparatus 10. FIG. 5 illustrates a configuration of those selected from the process blocks of the terminal apparatus 10 that are necessary for describing the terminal apparatus 10 according to the embodiment. As illustrated in FIG. 5, the terminal apparatus 10 includes the virtual printer driver 27, the real printer driver 28, the print job management plug-in 31, the communication part (transmitting part) 34, the intermediate print data storage part 43, and the printer driver information storage part 44.

Note that the virtual printer driver 27, the real printer driver 28, the display controller 33, and the communication part (transmitting part) 34 are already described above with reference to FIG. 4, and duplicated descriptions are thus omitted. The intermediate print data storage part 43 is configured to store the intermediate print data created by the virtual printer driver 27. The printer driver information storage part 44 is configured to store information on both the virtual printer driver 27 and the real printer driver 28 as printer driver information.

The print job management plug-in 31 in FIG. 5 includes a print data management part 41, and a print data process part 42. The print data management part 41 is configured to manage the intermediate print data stored by an intermediate print data storage part 43. The print data process part 42 is configured to create preview image data based on the intermediate print data stored by the intermediate print data storage part 43, change print settings, and instruct creating RAW data.

The terminal apparatus 10 in FIG. 4 is configured to aggregate processes by aggregating functions commonly utilized by the plural applications (plug-ins) 21 onto the platform 22. Note that the classification of the process block diagram in FIG. 4 is only an example, and it is not mandatory to comply with z hierarchal structure of the classification illustrated in FIG. 4.

### Image Forming Apparatus 12

The image forming apparatus 12 according to an embodiment may be able to be implemented by process blocks illustrated in FIG. 6, for example. FIG. 6 is a process block diagram illustrating an example of the image forming apparatus 12.

The image forming apparatus 12 in FIG. 6 is configured to implement an operations panel 51, a communication part 52, and a printing part 53, by executing programs. The operations panel part 51 is configured to receive input information input by the user and display information to the user by controlling an operations panel 602. The communication part 52 is configured to implement communications between the terminal apparatus 10 and the authentication device 11 or the image forming apparatus 12. The printing part 53 is configured to print RAW data onto sheets of paper by controlling the printer 605.

### Authentication Device 11

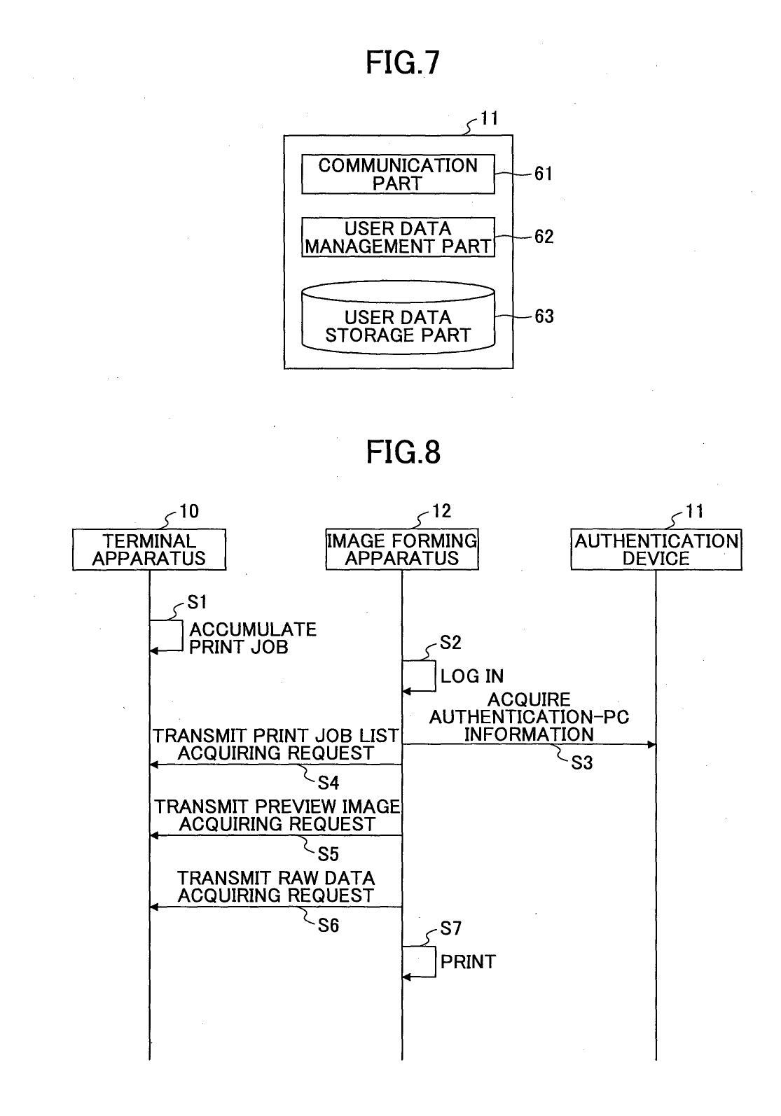

The authentication device 11 according to an embodiment may be able to be implemented by process blocks illustrated in FIG. 7, for example. FIG. 7 is a process block diagram illustrating an example of the authentication device 11.

The authentication device 11 in FIG. 7 is configured to implement a communication part 61, a user data management part 62, and a user data storage part 63, by executing programs. The communication part 61 is configured to implement communications between the image forming apparatus 12 and the authentication device 11. The user data storage part 63 is configured to store user data. The user data management part 62 is configured to manage the user data stored by the user data storage part 63.

### Details of Processes

In the following, a description is given of details of processes of the output system 1 according to the embodiment. In the following, a pull printing process is described as an example of an output process in the output system 1.

### Pull Printing Process

FIG. 8 is a sequence diagram illustrating an example of the pull printing process. In step S1, a user operates the terminal apparatus 10 to create application data by a desired application.

When receiving from the user a print instruction for printing the application data utilizing the virtual printer driver 27, the terminal 10 accumulates print jobs based on the print instruction from the user. The details of the print job accumulation will be described later.

In step S2, after accumulating print jobs, the user logs into the image forming apparatus 12 by operating the operations panel 602 of the image forming apparatus 12. In step S3, the image forming apparatus 12 requests the authentication device 11 to authenticate the user as well as acquiring information on the user's terminal apparatus 10 (PC information). When the authentication of the user is successful, the image forming apparatus 12 may be able to acquire the user's PC information.

In step S4, the image forming apparatus 12 requests the terminal apparatus 10 to acquire a print job list of the logged-in user's terminal apparatus 10 (PC information) utilizing the acquired user's PC information. The image forming apparatus 12 displays the acquired print job list on the operations panel 602.

When the user instructs the image forming apparatus 12 to display a preview image by operating the operations panel 602 of the image forming apparatus 12, the image forming apparatus 12 requests the terminal apparatus 10 to acquire the preview image data in step S5. The image forming apparatus 12 displays the acquired preview image on the operations panel 602 utilizing the acquired preview image data.

When the user instructs the image forming apparatus 12 to perform printing by operating the operations panel 602 of the image forming apparatus 12, the image forming apparatus 12 requests the terminal apparatus 10 to acquire RAW data in step S6. When acquiring the RAW data from the terminal 10, the image forming apparatus 12 performs printing utilizing the acquired RAW data.

Note that the sequence diagram in FIG. 8 illustrates an example in which the user's PC information is acquired from the authentication device 11. However, alternatively, the user's data including the user's PC information may be held by the image forming apparatus 12, or may be input by the user operating the operations panel 602 of the image forming apparatus 12. Note that the authentication device 11 is not mandatory for the output system 1.

### Print Job Accumulating Process

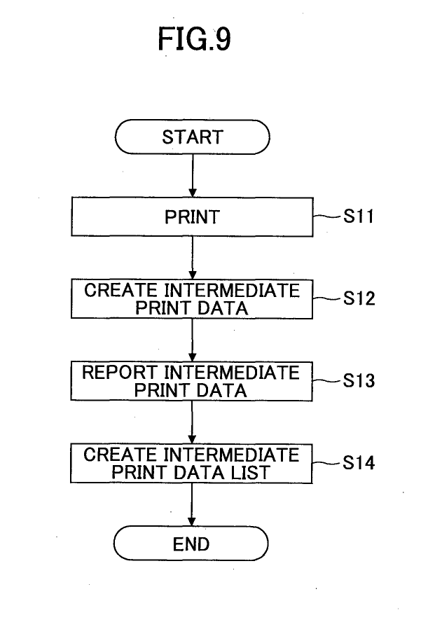

FIG. 9 is a flowchart illustrating an example of a print job accumulating process in the terminal apparatus 10. In step S11, the user operates the terminal apparatus 10 to select the virtual printer driver 27 from desired applications 21 and instructs the virtual printer driver 27 to print application data.

In step S12, the virtual printer driver 27 creates intermediate print data based on the application data. The virtual printer driver 27 stores the created intermediate print data in the intermediate print data storage part 43.

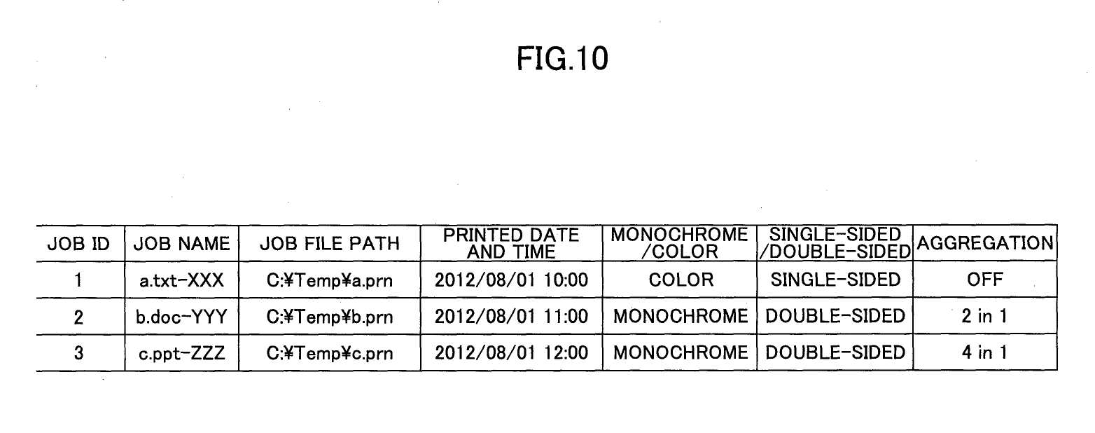

In step S13, the virtual printer driver 27 reports to the print data management part 41 that the intermediate print data are created and the created intermediate print data are stored in the intermediate print data storage part 43. When receiving the report from the virtual printer drive 27, the print data management part 41 creates an intermediate print data list illustrated in FIG. 10.

FIG. 10 is a configuration diagram illustrating an example of the intermediate print data list. The intermediate print data list illustrated in FIG. 10 includes items of a job ID, a job name, a job file path, printed date and time, and print settings (monochrome-color, single-double sided, aggregation etc.). As illustrated in FIGS. 9 and 10, in the print job accumulating process, print data independent of the model of the image forming apparatus 12 are accumulated by associating the print data with corresponding information of the print settings specified by the user.

### Login Process

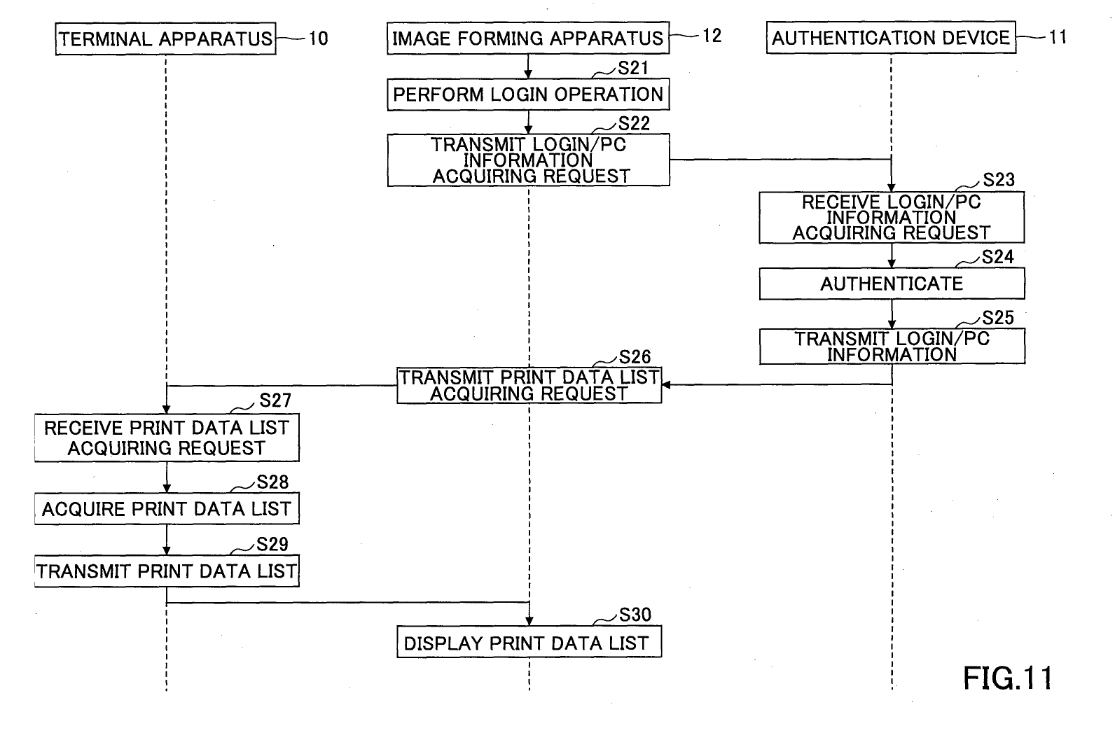

FIG. 11 is a sequence diagram illustrating an example of a login process. In step S21, after accumulating print jobs, the user performs a login operation via the operations panel 602 of the image forming apparatus 12. In step S22, the image forming apparatus 12 requests the authentication device 11 to acquire login/PC information.

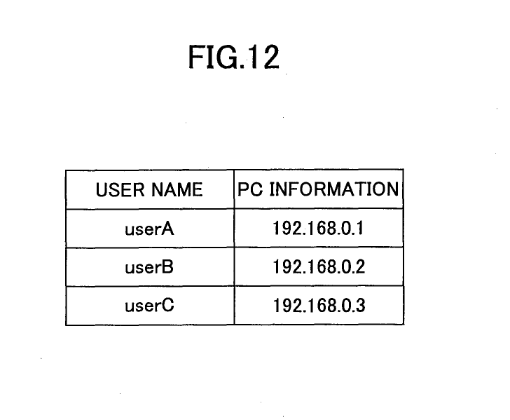

In step S23, the authentication device 11 authenticates the user who operates the image forming apparatus 12 utilizing user data stored by the user data storage part 63 as illustrated, for example, in FIG. 12.

FIG. 12 is a configuration diagram illustrating an example of the user data. The user data in FIG. 12 includes items of a user name and PC information. The PC information includes information on the terminal apparatus 10 used by the user. The user name is an example of identifier information for identifying the user. Alternatively, the identifier information may, for example, be an identification number of the terminal apparatus 10 or a card owned by the user.

Further, FIG. 12 illustrates an example in which an IP address serves as the PC information. When the authentication of the user is successful, the authentication device 11 acquires PC information from the user data of the user who has succeeded in being authenticated, and transmits to the image forming apparatus 12 the acquired PC information together with the authentication result in step S25.

In step S26, when receiving the user's PC information from the authentication device 11, the image forming apparatus 12 requests the terminal apparatus 10 specified by the user's PC information to acquire a print data (a print job) list. In step S27, the terminal apparatus 10 receives a print data list acquiring request from the image forming apparatus 12.

In step S28, the print data management part 41 of the terminal apparatus 10 acquires a print data list based on the intermediate print data list illustrated in FIG. 10. In other words, the terminal apparatus 10 acquires the print job list that the user has accumulated as the print jobs in step S1.

In step S29, the terminal apparatus 10 transmits the print data list acquired by the print data management part 41 to the image forming apparatus 12. In step S30, the image forming apparatus 12 displays the print data list acquired from the terminal apparatus 10 on the operations panel 602.

Hence, the user operating the image forming apparatus 12 may be able to check the print job list accumulated as the print jobs in the terminal apparatus 10 via the operations panel 602 and the like of the image forming apparatus 12.

### Preview Image Display Process

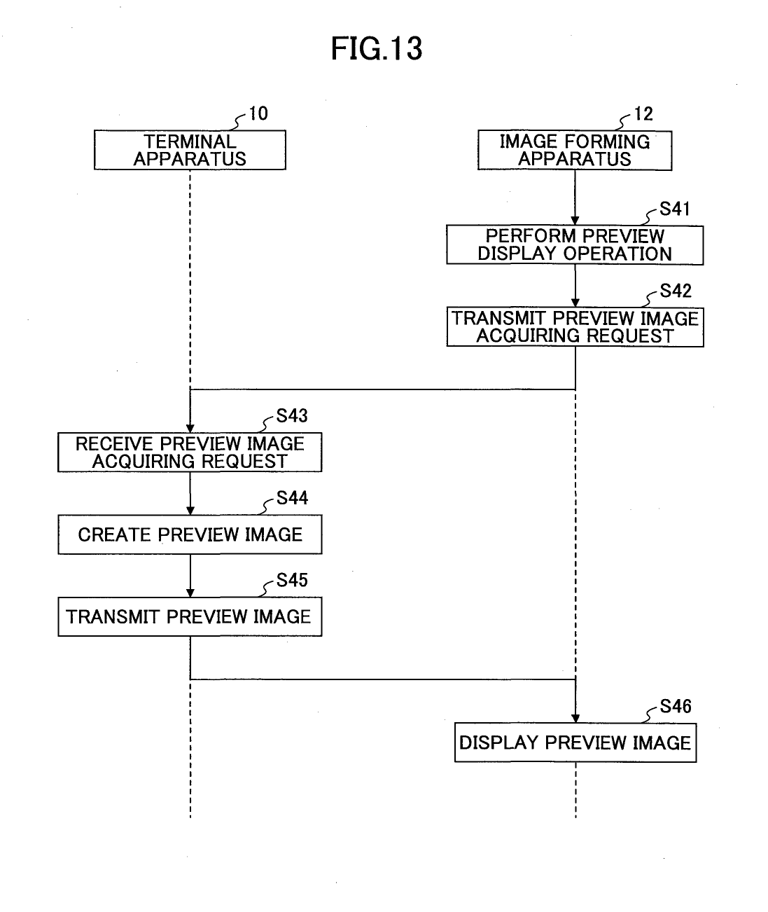

FIG. 13 is a sequence diagram illustrating an example of a preview image display process. In step S41, the user performs a display operation to display a preview image via the operations panel 602 of the image forming apparatus 12.

In step S42, the image forming apparatus 12 requests the terminal apparatus 10 to acquire a preview image. In step S43, the terminal apparatus 10 receives the preview image acquiring request from the image forming apparatus 12.

In step S44, the print data process part 42 of the terminal apparatus 10 creates preview image data based on the intermediate print data stored in the intermediate print data storage part 43. In step S45, the terminal apparatus 10 transmits the preview image data created by the print data process part 42 to the image forming apparatus 12. In step S46, the image forming apparatus 12 displays the preview image on the operations panel 602 utilizing the preview image data acquired from the terminal apparatus 10.

Hence, the user operating the image forming apparatus 12 may be able to check the preview images of the print jobs accumulated in the terminal apparatus 10 via the operations panel 602 and the like of the image forming apparatus 12. In this embodiment, the preview image data are created based on the intermediate print data, which may be easier than creating the preview image data based on the RAW data, which are dependent on the model of the image forming apparatus (model dependent).

### Printing Process

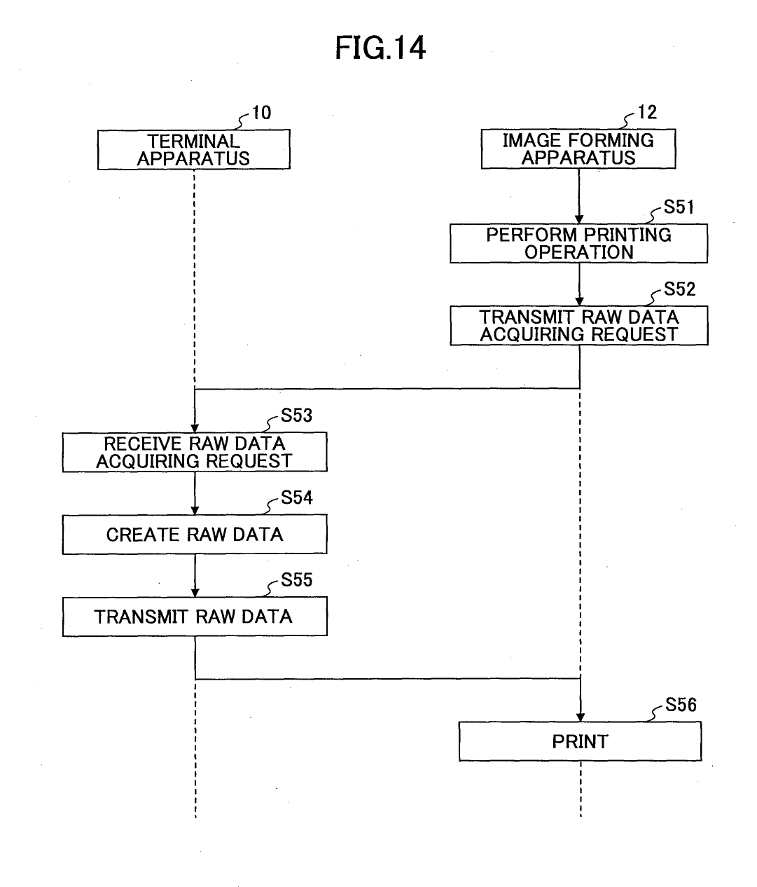

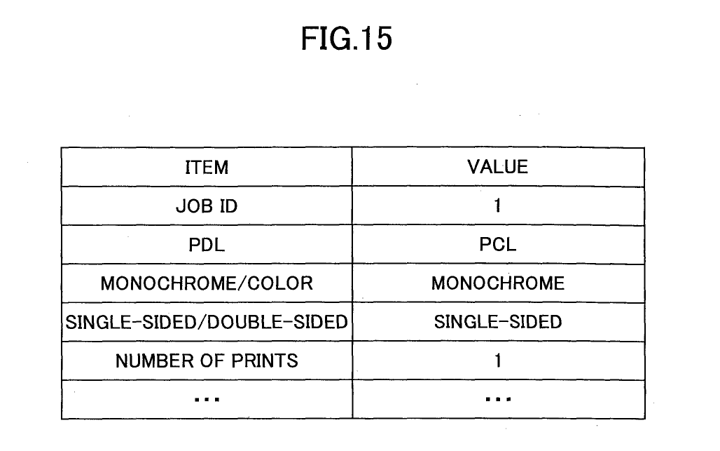

FIG. 14 is a sequence diagram illustrating an example of a printing process. In step S51, the user performs a printing operation via the operations panel 602 of the image forming apparatus 12. In step S52, the image forming apparatus 12 requests the terminal apparatus 10 to acquire RAW data such as those illustrated in FIG. 15.

FIG. 15 is a configuration diagram illustrating an example of a RAW data acquiring request.

The RAW data acquiring request illustrated in FIG. 15 includes items of a job ID, a PDL, and print settings (monochrome-color, single-double sided, aggregation, etc.).

In step S53, the terminal apparatus 10 receives the RAW data acquiring request from the image forming apparatus 12. In step S54, the print data process part 42 of the terminal apparatus 10 selects a real printer driver 28 corresponding to the image forming apparatus 12, and instructs the real printer driver 28 to create RAW data. The real printer driver 28 creates print data in a RAW format based on the intermediate print data stored by the intermediate print data storage part 43.

Note that in step S54, the print data process part 42 changes the print settings when the print settings of the intermediate print data subject to printing that are included in the intermediate print data list illustrated in FIG. 10 differ from the print settings included in the RAW data acquiring request illustrated in FIG. 15. In step S55, the terminal apparatus 10 transmits the RAW data created by the real printer driver 28 to the image forming apparatus 12. Then, in step S56, the image forming apparatus 12 performs printing utilizing the RAW data acquired from the terminal apparatus 10.

Hence, the user operating the image forming apparatus 12 may be able to execute printing the print jobs accumulated in the terminal apparatus 10 by instructing the image forming apparatus to print the accumulated print jobs via the operations panel 602 and the like of the image forming apparatus 12.

Further, the user operating the image forming apparatus 12 may be able to instruct printing the print jobs or execute printing the print jobs accumulated in the terminal apparatus 10 via the operations panel 602 and the like of the image forming apparatus 12 after changing the print settings.

In this embodiment, the RAW data are created based on the intermediate print data after the user has performed the printing operation via the operations panel 602 of the image forming apparatus 12. In this embodiment, the model dependent RAW data are created after changing the print settings in the intermediate print data, which may be easier than changing the print settings in the RAW data.

Note that the present embodiment illustrates an example without using a print server; however, the embodiment is not limited to this example. The embodiment may employ the print server. In the embodiment employing the print server, the intermediate print data created by the terminal apparatus 10 in the print job accumulating process may, for example, be accumulated in the print server.

In the embodiment employing the print server, the image forming apparatus 12 that is logged in by the user transmits the print job list acquiring request, the preview image acquiring request, the RAW data acquiring request, and the like to the print server. Hence, the terminal apparatus 10 does not have to accumulate the intermediate print data.

The output system 1 according to the embodiment may be employed by an output system according to another embodiment having mixed image forming apparatuses 12 produced by different manufacturers in an environment such as an office. For example, when the user desires to output the print jobs from an image forming apparatus 12 produced by a different manufacturer into which the above-described applications (plug-ins) are not installable, the user may cause a mobile terminal to execute the processes in steps S2 to S6. The user may be able to print RAW data and the like with the image forming apparatus into which the above-described applications (plug-ins) are not installable via the mobile terminal.

The present embodiment may facilitate handling of the print data in the image forming apparatus 12 such as displaying the preview image on the operations panel 602 of the image forming apparatus 12 or changing the print settings by accumulating the print jobs in a print data format independent of the model of the image forming apparatus 12.

The present invention is not limited to the embodiments specifically disclosed above, and numerous variations and modifications may be made without departing from the scope of the present invention. It is noted that the first data creating unit described in the claims corresponds to the virtual printer driver 27. The second data creating unit corresponds to the real printer driver 28.

The disclosed embodiments may facilitate handling data to be output in the image forming apparatus.

While certain preferred embodiments of the present invention have been described above, the present invention is not limited to these embodiments, and numerous variations and modifications may be made without departing from the scope of the present invention.

The present application is based on and claims the benefit of priority of Japanese Patent Application No. 2012-285040 filed on Dec. 27, 2012, the entire contents of which are hereby incorporated by reference.

1. A terminal apparatus capable of communicating with at least one image forming apparatus via a network, the terminal apparatus, comprising:
a storage part;
a data management unit configured to manage intermediate print data stored in the storage part, the intermediate print data being created based on application data in response to first print instruction of a user, and being independent of the image forming apparatus;
an output data process unit configured to instruct a print data creating unit to create the print data based on the intermediate print data stored in the storage part in response to receiving a print data acquiring request from the image forming apparatus that has sent the print data acquiring request to the terminal apparatus of the user who is authenticated with respect to the image forming apparatus via the network, the print data being dependent on the image forming apparatus; and
a transmitting unit configured to transmit the created print data to the image forming apparatus.

2. (canceled)

3. The terminal apparatus as claimed in claim 1, wherein
when the data management unit receives an intermediate print data list acquiring request to acquire a list of the intermediate print data stored in the storage part, the data management unit creates the list of the intermediate print data to output the created list of the intermediate print data to the transmitting unit.

4. The terminal apparatus as claimed in claim 1, wherein
when the output data process unit receives an intermediate print data preview image acquiring request to acquire a preview image of the intermediate print data stored in the storage part, the output data process unit creates the preview image of the intermediate print data based on the intermediate print data to output the created preview image of the intermediate print data to the transmitting unit.

5. The terminal apparatus as claimed in claim 1, wherein
when a first output setting of the intermediate print data differs from a second output setting of the print data, the output data process unit instructs the print data creating unit to create the print data based on the intermediate print data stored in the storage part after the output data process unit changes an output setting to the second output setting of the print data.

6. The terminal apparatus as claimed in claim 1, wherein
the intermediate print data are data in an XML paper specification (XPS) format, and the print data are data in a RAW format.

7. The terminal apparatus as claimed in claim 1, wherein
the print data creating unit is a printer driver configured to create the print data.

8. An output system including at least one terminal apparatuses and at least one image forming apparatus, the at least one terminal apparatus communicating with the at least one image forming apparatus via a network, the output system comprising:
a storage part in the terminal apparatus;
a data management unit in the terminal apparatus, the data management unit being configured to manage intermediate print data stored in the storage part, the intermediate print data being created based on application data in response to first print instruction of a user, and being independent of the image forming apparatus;
a user information receiving unit in the image forming apparatus, the user information receiving unit being configured to receive an address of the terminal apparatus of the user who is authenticated with respect to the image forming apparatus via the network;
a list display unit in the image forming apparatus, the list display unit being configured to display a list of the intermediate print data stored in the storage part of the terminal apparatus of the authenticated user;
a print data acquiring request unit in the image forming apparatus, the print data acquiring request being configured to send a print data acquiring request to the terminal apparatus of the authenticated user to acquire print data in response to second print instruction of the authenticated user;
an output data process unit in the terminal apparatus, the output data process unit being configured to instruct a print data creating unit to create the print data based on the intermediate print data stored in the storage part in response to receiving the print data acquiring request, the print data being dependent on the image forming apparatus;
a transmitting unit in the terminal apparatus, the transmitting unit being configured to transmit the created print data to the image forming apparatus; and
an output unit in the image forming apparatus, the output unit being configured to output the transmitted print data.

9. The output system as claimed in claim 8, further comprising:
an authentication unit configured to authenticate a user who operates the image forming apparatus, wherein
the authentication unit transmits information on the terminal apparatus used by the user to the image forming apparatus.

10. The output system as claimed in claim 8, wherein
when the output data process unit receives an intermediate print data preview image acquiring request to acquire an intermediate print data preview image of the intermediate print data stored in the storage part, the output data process unit creates the intermediate print data preview image based on the intermediate print data to output the created intermediate print data preview image to the transmitting unit.

11. The output system as claimed in claim 8, wherein
when a first output setting of the intermediate print data differs from a second output setting of the print data, the output data process unit instructs the print data creating unit to create the print data based on the intermediate print data stored in the storage part after the output data process unit changes an output setting to the second output setting of the print data.

12. An output method in an output system, the output system including at least one terminal apparatus and at least one image forming apparatus, the at least one terminal apparatus communicating with the at least one image forming apparatus via a network, the output method comprising:
managing intermediate print data stored in a storage part, the intermediate print data being created based on application data in response to first print instruction of a user, and being independent of the image forming apparatus;
receiving an address of the terminal apparatus of the user who is authenticated with respect to the image forming apparatus via the network;
displaying a list of the intermediate print data stored in the storage part of the terminal apparatus of the authenticated user;
sending a print data acquiring request to the terminal apparatus of the authenticated user to acquire print data in response to second print instruction of the authenticated user;
instructing a print data creating unit to create the print data based on the intermediate print data stored in the storage part in response to receiving the print data acquiring request, the print data being dependent on the image forming apparatus;
transmitting the created print data to the image forming apparatus; and
outputting the transmitted print data.

13. The output method as claimed in claim 12, further comprising:
authenticating a user who operates the image forming apparatus; and
transmitting information on the terminal apparatus used by the user to the image forming apparatus.

14. The output method as claimed in claim 12, further comprising:
creating a preview image based on the intermediate print data to output the created preview image of the intermediate print data when an intermediate print data preview image acquiring request is received, the intermediate print data preview image acquiring request being a request to acquire the preview image of the intermediate print data stored in the storage part.

15. The output method as claimed in claim 12, further comprising:
instructing, when a first output setting of the intermediate print data differs from a second output setting of the print data, the print data creating unit to create the print data based on the intermediate print data stored in the storage part after an output setting is changed to the second output setting of the print data.
